(19) United States
(12) Patent Application Publication
(10) Pub. No.: US 2013/0332817 A1
(43) Pub. Date: Dec. 12, 2013

(54) METHOD AND A SYSTEM FOR MANAGING THIRD PARTY OBJECTS FOR A WEBSITE

(71) Applicants: Michael SEIFERT, Charlottenlund (DK); Peter Christian LAUB, Farum (DK); Mikkel Høy SØRENSEN, Ringsted (DK)

(72) Inventors: Michael SEIFERT, Charlottenlund (DK); Peter Christian LAUB, Farum (DK); Mikkel Høy SØRENSEN, Ringsted (DK)

(73) Assignee: SITECORE A/S, Kobenhavn V (DK)

(21) Appl. No.: 13/494,581

(22) Filed: Jun. 12, 2012

(51) Int. Cl. G06F 17/00; G06F 15/16

(52) U.S. Cl. 715/234

(57) ABSTRACT

A method and system for managing a website by a content management system (CMS) are provided. The website and the CMS reside on a server. The CMS obtains, from a remote server, information regarding objects which may form part of webpages supplied to a visitor of the website. Each of the objects includes reference to one or more third party services, e.g. in the form of websites, web services or web servers. When a visitor requests a webpage of the website, the CMS dynamically generates a webpage matching the request of the visitor. This includes the CMS injecting one or more objects into the webpage in accordance with one or more predefined rules and the information obtained from the remote server. Finally, the CMS supplies the generated webpage to the visitor. The CMS controls the injections of objects, e.g., in the form of tags, into the webpages of the website.

### FIELD OF THE INVENTION

The present invention relates to a method and a system for managing a website by means of a content management system (CMS). Webpages of the website are dynamically generated by the CMS upon request by a visitor visiting the website.

### BACKGROUND OF THE INVENTION

It is sometimes desirable to provide websites with objects. The objects may not be visible to a visitor of the website, but may cause background events to occur, such as the visitor's browser contacting an analytics service in order to obtain web analytics regarding the visit. As an alternative, the objects may be visible to a visitor of the website, in which case the objects may, e.g., be or comprise banner ads. The objects may, e.g., be in the form of so-called tags. Previously, such objects had to be inserted directly into the code of the website. Since most web managers are not capable of producing such code, the web manager has to contact a programmer if he or she wants to add, remove or alter the objects.

In order to solve this problem, tag management services offer to manage objects of websites for the website owner or manager. These services operate in the following manner. A programmer inserts objects in the code of the website. The objects instruct the visitor's browser to contact the tag management service. When this happens, the tag management service ensures that the functionality which is desired by the website owner or manager is performed and returned back to the visitor's browser which then in turn, e.g., contacts an analytics server. The web manager may configure which functionality is desired via a user interface to the tag management service. In the case that the website owner or manager wants to add, remove or alter the objects, he or she must use the tag management service user interface and/or ask a programmer to change the inserted objects. In turn, the tag management service ensures that any requested updates are performed, and therefore eventually returned to the visitor's browser.

US 2010/0095197 discloses a system and a method for dynamic content publishing. In one aspect, the software identifies a content repository of structured dynamic content associated with information for a webpage comprising unstructured static content. The software inserts a metadata data structure defining a set of the structured dynamic content into the unstructured static content of the webpage to create a tag-enriched webpage.

### DESCRIPTION OF THE INVENTION

It is an object of embodiments of the invention to provide a method for managing a website which allows a web manager to easily manage objects of the website without the requirement for using a tag management service.

It is a further object of embodiments of the invention to provide a method for managing a website, which allows webpages to be generated dynamically, including relevant objects.

It is an even further object of embodiments of the invention to provide a system for managing a website, which allows a website owner or manager to easily manage objects of the website without the requirement for using a tag management service.

It is an even further object of embodiments of the invention to provide a system for managing a website, which allows webpages to be generated dynamically, including relevant objects.

According to a first aspect the invention provides a method for managing a website by means of a content management system (CMS), said website residing on a server, the method comprising the steps of:
the content management system obtaining, from a remote server, information regarding objects which may form part of webpages supplied to a visitor of the website, each of said objects comprising reference to one or more third party services,
a visitor requesting a webpage of the website,
the content management system dynamically generating a webpage matching the request of the visitor, including the content management system injecting one or more objects into the webpage in accordance with one or more predefined rules, and in accordance with the information obtained from the remote server, and
the content management system supplying the generated webpage to the visitor.

In the present context the term ‘website’ should be interpreted to mean a collection of related web pages, images, videos or other digital assets being addressed relative to a common Uniform Resource Locator (URL). The web pages of the website may advantageously be designed, presented and linked together to form a logical information resource and/or transaction initiation function. According to the first aspect of the invention, the website being managed is arranged on, or hosted on, a server. The server, and thereby the website, is typically accessible via a data network, such as the Internet or a Local Area Network (LAN). It should be noted that, in the present context, the term ‘server’ should be interpreted to cover a single device as well as two or more individual devices being interlinked in such a manner that they, to a visitor of the website, seem to act as a single device.

In the present context the term ‘content management system’, or ‘CMS’, should be interpreted to mean a system, which allows a website manager or editor to create and edit content of a website.

According to the method of the first aspect of the invention, the content management system initially obtains information from a remote server. In the present context the term ‘remote server’ should be interpreted to mean a server, which is separate from the server on which the website and the content management system reside.

The information obtained from the remote server relates to objects which may form part of webpages supplied to a visitor of the website, each object comprising reference to one or more third party services. In the present context the term ‘third party services’ should be interpreted to mean services which are performed by a party which is not the owner of the website being managed by means of the method of the first aspect of the invention. Third party services could, e.g., be in the form of third party web contents, third party websites, third party web services, third party servers, etc. For instance, a third party service could be an analysis service, such as Google® Analytics, providing analytics regarding the visitors of the website to the website owner, or Google® Ad Words providing adwords directly in the generated webpage.

At a certain point in time a visitor requests a webpage of the website. The visitor preferably contacts the website via a client device, e.g. in the form of a personal computer, a tablet, a cell phone, etc., having a suitable web browser installed thereon, allowing the visitor to access websites via a communication channel, such as the Internet. The visitor may contact the website by means of a browser installed on a client device.

It should be noted that the step of the content management system obtaining information from the remote server may be performed independently of the step of a visitor requesting a webpage of the website. In this case the content management system simply contacts the remote server, or the remote server contacts the content management system, whenever it is considered suitable, e.g. at regular time intervals and/or if updates are available, and the content management system will always have the most recent information available when a visitor requests a webpage of the website. As an alternative, the content management system may contact the remote server upon request of a webpage by a visitor.

Upon the request for the webpage by the visitor, the content management system dynamically generates a webpage matching the request of the visitor. This includes injecting one or more objects into the webpage in accordance with one or more predefined rules, and in accordance with the information obtained from the remote server. Thus, the generated webpage contains the objects which the predefined rules and the information obtained from the remote server prescribes.

The predefined rules determine which objects should be injected into which webpages, and under which circumstances. For instance, one rule could specify that a specific object must be injected into the first webpage which is provided to the visitor. Another rule could specify that a given object should be injected when a given webpage is requested. Yet another rule could specify that a given object must be injected into certain webpages requested by visitors with a given profile. Alternatively or additionally, other suitable rules can be applies, as long as the rules reflect which objects the website owner wants to be injected into the webpages under the given circumstances.

Finally, the content management system supplies the generated webpage to the visitor.

Thus, according to the first aspect of the invention the content management system controls the process of providing the objects in the webpages of the website, including obtaining the necessary information from the remote server, and injecting appropriate objects at appropriate positions on the webpages of the website, when a visitor requests a webpage. This is an advantage, because the injection of objects on the webpages of the website can thereby be managed easily without having to use a tag management service.

The method may further comprise the step of the content management system storing the information regarding the objects, obtained from the remote server, at the server, and the step of the content management system dynamically generating a webpage may be performed in accordance with the information obtained from the remote server and stored at the server. According to this embodiment, the content management system may obtain the information from the remote server at any suitable time, and the obtained information is stored locally, e.g. as cached data. When a visitor requests a webpage of the website, the relevant information regarding the objects is already available locally, and the content management system is capable of injecting appropriate objects at appropriate locations at the requested webpage, without having to contact the remote server first. Thereby the response time of the website is minimised.

However, as described above, the content management system may alternatively contact the remote server upon request for a webpage by a visitor, in order to obtain the required information regarding the objects.

At least one of the objects may be a tag. In the present context a ‘tag’ could be a container tag that allows tags, scripts or properties to be inserted by a third party system, e.g. a tag management system. As an alternative a ‘tag’ could be HTML mark-up, e.g. in the form of a script, such as a Google® Analytics script. A tag can contain parameters further defining the behaviour of the third party object.

At least one of the objects may contain instructions to a browser of the visitor to contact a third party website or web service. According to this embodiment, when the visitor accesses the requested webpage, via a browser arranged on a client device, the browser also receives instructions to contact a given third party website or web service. Thus, in this case the reference to one or more third party services is these instructions to contact the third party website or web service. The browser of the visitor then contacts the third party website or web service. The third party website or web service may provide additional information or functionality to the browser of the visitor, thereby affecting the content being presented to the visitor. Alternatively or additionally, the third party website or web service may retrieve information from the browser of the visitor, e.g. for analysis purposes. This will be described in further detail below.

The third party website or web service may comprise functionality. According to this embodiment, the functionality is activated when the browser of the visitor contacts the third party website or web service. The functionality may, e.g., be or comprise analytics functionality collecting information regarding the visitor and/or the visit. Alternatively or additionally, the functionality may be or comprise BI analytics, banner ads, PPC ads, bid management, visitor detection, device detection, location services, SSO management, behavioural tracking and analysis, content recommendation, heat maps, social media integration, tag management, etc.

Thus, the third party website or web service may be adapted to collect and analyse information about the visitor during a visit to the website. In this case the third party website or web service may, e.g., be Google® Analytics, Google® AdWords, Omniture, WebTrends, CoreMetrics, Targit BI, Baynote, etc.

In the case that the third party website or web service is adapted to collect and analyse information about the visitor, the information collected and analysed may include behaviour of the visitor during a visit to the website. The behaviour of the visitor may, e.g., include navigations and actions performed by the visitor during the visit, such as viewed content, performed tests, performed polls, navigational sequences, etc.

The CMS may further be adapted to supply values to third party services. For instance, the CMS may be capable of supplying engagement values or other metrics about a visit or a visitor to the third party service.

At least one of the objects may contain instructions to a browser of the visitor to contact a tag management service. According to this embodiment, when the webpage is supplied to the visitor, via the visitor's browser, the browser contacts a tag management service which the website owner may have used prior to implementing the present invention and/or which the website owner may be using for other websites where the present invention has not been implemented. Thus, the website owner may still use the tag management service for managing the objects, such as tags, of the website, while also obtaining the advantages of the content management system inserting the objects onto the webpages as described above. Thus, according to this embodiment, the content management system injects relevant objects at relevant positions of a webpage while dynamically generating the webpage, and the tag management service, when contacted by the browser of the visitor, defines what actions should be taken, e.g. whether or not an analysis service should be contacted, and what kind of analysis should possibly be performed and by which analysis service. This will in turn make the visitor's browser contact the third party services directly via the inserted objects, and contact the tag management service via the objects referring to the tag management service, which for the purpose is simply another third party service to be contacted.

At least one of the objects may be adapted to return content which becomes visible in the browser of the visitor. For instance, a property of an object may set the visibility of the object to the visitor.

The step of the content management system obtaining information regarding objects may be repeated in accordance with one or more predefined rules. According to this embodiment, the content management system receives updated information regarding the objects each time the step is performed. Thereby it can be ensured that the most recent information is always available to the content management system when a webpage is requested by a visitor. For instance, the step may be repeated at regular time intervals, such as once every hour, once every day, once every week, once every month, etc. Alternatively or additionally, the step may be repeated in response to specific events occurring. The events may, e.g., include changes in the information regarding the objects being defined at the remote server and/or at a third party service referred to by one or more objects. As an alternative, the events may, e.g., include the website owner adjusting one or more rules, adding one or more rules or removing one or more rules relating to the injection of the objects into the webpages of the website.

The remote server may be or form part of a cloud based service system. In the present context the term ‘cloud based service system’ should be interpreted to mean a service system which runs on the remote server, via a computer network, such as the Internet, rather than running on the server having the website arranged thereon.

The method may further comprise the steps of the content management system obtaining, from the remote server, information regarding the one or more predefined rules, and the content management system storing the information regarding the one or more predefined rules at the server. According to this embodiment, information about the predefined rules, which are applied in order to decide which objects to inject while dynamically generating the webpage requested by the visitor, is available at the remote server. The content management system obtains the information regarding the rules from the remote server, e.g. in the manner which the content management system obtains information regarding the objects, and possibly simultaneously with obtaining the information regarding the objects. However, the information regarding the predefined rules may, alternatively, be obtained independently of the information regarding the objects. Once obtained from the remote server, the information regarding the predefined rules is stored at the server. Thereby the predefined rules are available to the content management system when a webpage is requested by a visitor, and delays in providing the requested webpage to the visitor can thereby be minimised. The information regarding the predefined rules may be obtained and stored once and for all. Alternatively, updated information regarding the predefined rules may be obtained and stored at regular intervals and/or in response to specific events, such as updates to the rules occurring at the remote server.

The step of the content management system dynamically generating a web page may comprise injecting one or more objects into the webpage in accordance with one or more predefined rules relating to a profile of the visitor, the dynamically generated webpage thereby being customized. The profile of the visitor could, e.g., reflect the behaviour of the visitor during the visit, political point of view, GeoIP information, age, gender, place of residence, or other demographic describing parameters, the visit number, the page number seen, time on a given page, conversions, what marketing activity brought them to the site, engagement value points accumulated by the visit and/or the visitor, social profiles and/or any other relevant information regarding the visitor. Thus, according to this embodiment, the objects which are injected into the webpage are selected in such a manner that they match the profile of the visitor, or those values are supplied to the third party service(s). For instance, the accumulated engagement value points, e.g. stemming from CMS analytics, could be supplied as a parameter to one or more of the third party services.

The method may further comprise the step of generating a profile for the visitor during the visit. According to this embodiment, a profile is initially generated when the visitor accesses the website. The profile may, e.g., be generated on the basis of the behaviour of the visitor at the website, such as content viewed and/or actions performed by the visitor.

As an alternative to generating the profile for the visitor, the profile may be obtained in another manner. For instance, a profile of the visitor may have been generated during a previous visit to the website by the visitor. In this case, the visitor is initially identified in order to retrieve the previously generated profile. This may, e.g., be done by the visitor logging in, by client cookie recognition, or by the system identifying an IP address of a client device used by the visitor. As an alternative, the profile may be generated by a separate system and provided to the content management system.

Alternatively or additionally, the step of the content management system dynamically generating a web page may comprise injecting one or more objects into the webpage in accordance with one or more predefined rules relating to the webpage being generated. According to this embodiment, the objects being injected into the webpage are selected in such a manner that they match the webpage being generated. According to this embodiment, one or more of the predefined rules may define where on a given webpage, or on a given type of webpage, specific objects should be injected. For instance, it may be desired to do a heatmap for visits to the front page. In this case one rule should specify, that in the case that a visitor requests the front page, an object is injected into the webpage, which ensures that the desired heatmap is performed.

The method may further comprise the step of storing one or more objects at the server. According to this embodiment, objects may be obtained from the remote server, e.g. along with the information regarding the objects. The obtained objects are then stored at the server, and thereby they are readily available for injection into a webpage being dynamically generated by the content management system, when a visitor requests the webpage. As an alternative, the objects may be obtained from another website or server, or they may be generated directly on the server.

The method may further comprise the step of a web manager accessing the remote server via a user interface in order to define one or more rules to be applied during the step of dynamically generating a webpage. According to this embodiment, a web manager, which may not possess any programming skills, is allowed to access the remote server via the user interface. When doing so, the web manager may add, remove or change rules which are to be applied when the content management system dynamically generates a webpage upon request from a visitor. Thereby it is easy for the web manager to manage the rules, and thereby to manage which objects are injected into the webpages of the website, as well as Where and how the objects are injected. Alternatively or additionally, the web manager may be able to define one or more objects via the user interface.

Alternatively or additionally, the method may further comprise the step of a web manager accessing the content management system via a user interface in order to define one or more rules to be applied during the step of dynamically generating a webpage. This is similar to the embodiment described above, and the remarks set forth above are therefore equally applicable here. However, according to this embodiment, the web manager accesses the content management system in order to manage the applied rules, instead of accessing the remote server.

As an alternative, the management of the predefined rules and/or the information regarding the objects may be handled by a service provider. In this case the service provider may handle the remote server. According to this embodiment, the website owner or manager may subscribe to certain categories, types and/or providers of objects and/or third party websites or services. Rules residing on the remote server may then ensure that rules being applied during dynamic generation of webpages, and/or objects, are added, removed or changed automatically, e.g. in response to changes in services provided by third party websites or services. For instance, the website owner or manager may have subscribed to a specific third party service providing desired data, features, analytics, etc. to the website. In the case that the service provider chooses to use a different third party service providing the same or similar services, the subscription of the website owner or manager may be changed to apply the new third party service. In this case, the rules and the objects should be changed in such a manner that functionality relating to the new third party service is injected into webpages being generated, instead of functionality relating to the previous third party service.

Alternatively or additionally, the method may further comprise the step of the remote server communicating with the third party service in order to provide information regarding one or more objects and/or regarding one or more predefined rules from the third party service to the remote server. According to this embodiment, the remote server obtains the relevant information regarding the objects and/or regarding the predefined rules directly from the third party service. The step may be performed once and for all, or it may be repeated, e.g. at regular time intervals and/or in response to specific events, similar to the situation described above. Thereby updated information is always and automatically available at the remote server.

According to a second aspect the invention provides a system for managing a website arranged on a server, the system comprising:
a content management system (CMS) arranged on the server, the content management system allowing a visitor to request a web page of the website,
a remote server having information regarding objects residing thereon, each of said objects comprising reference to one or more third party services, and
a communication channel allowing the content management system to obtain information regarding objects from the remote server,
   wherein the content management system is capable of dynamically generating a webpage matching a request from a visitor to the website, including the content management system injecting one or more objects into the webpage in accordance with one or more predefined rules, and in accordance with information obtained from the remote server.

The system according to the second aspect of the invention is suitable for performing the method according to the first aspect of the invention. Accordingly, a person skilled in the art would readily recognise that any feature described in combination with the first aspect of the invention could also be combined with the second aspect of the invention, and vice versa.

Thus, any remark set forth above with reference to the first aspect of the invention is equally applicable here.

The system may further comprise a storage device arranged on the server for storing information, obtained from the remote server, regarding objects. According to this embodiment, the information regarding objects is readily available to the content management system when a visitor requests a webpage of the website, and thereby delays in providing the requested webpage to the visitor can be minimised. This has already been described in detail above.

The remote server may comprise a user interface allowing a web manager to access the remote server in order to define one or more rules to be applied when dynamically generating a webpage. According to this embodiment, a web manager can easily manage the rules and objects, via the remote server. Alternatively or additionally, the user interface may allow the web manager to define one or more objects to be injected into webpages being dynamically generated. This has already been described in detail above.

Alternatively or additionally, the server may comprise a user interface allowing a web manager to access the content management system in order to define one or more rules to be applied when inserting objects into dynamically generated webpages. According to this embodiment, the web manager accesses the server, possibly the content management system, instead of the remote server. This has already been described in detail above.

### BRIEF DESCRIPTION OF THE DRAWINGS

The invention will now be described in further detail with reference to the accompanying drawings in which

FIG. 1 is a block diagram illustrating a system according to an embodiment of the invention,

FIG. 2 is a flow diagram illustrating a method according to a first embodiment of the invention,

FIG. 3 is a flow diagram illustrating a method according to a second embodiment of the invention, and

FIG. 4 is a flow diagram illustrating a method according to a third embodiment of the invention.

### DETAILED DESCRIPTION OF THE DRAWINGS

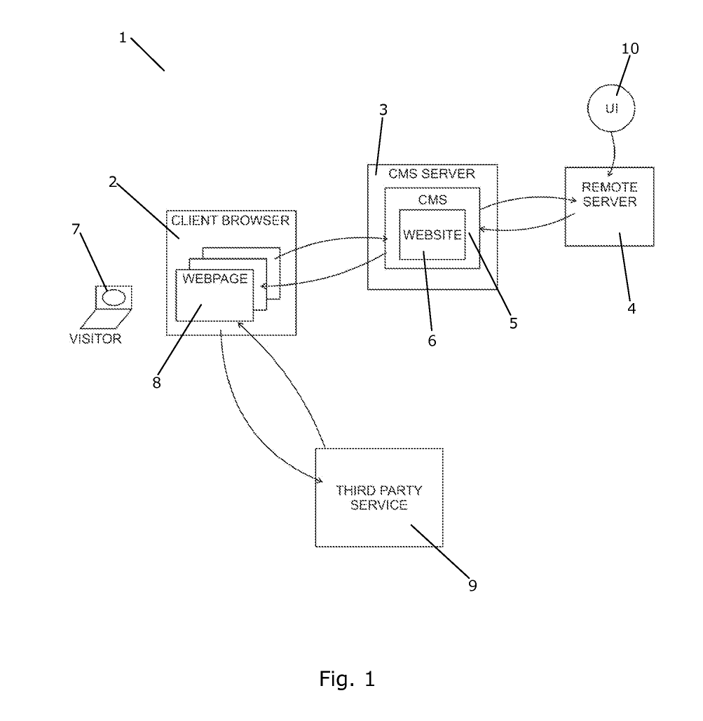

FIG. 1 is a block diagram illustrating a system 1 according to an embodiment of the invention.

The system 1 comprises a client browser 2 residing on a client device, a content management (CMS) server 3, and a remote server 4. The client browser 2 is adapted to allow a visitor to gain access to content of various websites, via a network.

The CMS server 3 has a content management system (CMS) 5 and a website 6 residing thereon. The CMS 5 allows a website manager or editor to create and edit content of the website 6. The website 6 contains content which is available to visitors via a public or private network, e.g. the Internet or an intranet.

It should be noted, that even though the CMS server 3 is shown as a single server device, it could, alternatively, include two or more devices, which may be located adjacent to each other or remote from each other, e.g. at different locations. For instance, the CMS server may comprise a CMS delivery server being responsible for delivering content to visitors, and a CMS authoring server which allows a web manager to access the CMS 5 in order to manage the website.

The remote server 4 is arranged remotely with respect to the CMS server 3. The remote server 4 may, e.g., be owned and/or operated by a service provider which manages objects which may be injected into webpages and/or rules governing the injection of such objects, on behalf of website owners.

A communication channel exists between the CMS server 3 and the remote server 4, allowing the CMS server 3 and the remote server 4 to communicate. This allows the CMS 5 to obtain information regarding objects which may form part of webpages of the website 6, from the remote server 4. The objects comprise reference to one or more third party services, e.g. in the form of third party websites, third party web services, third party web servers, etc. Since the CMS 5 obtains information regarding the objects, the CMS 5 is capable of injecting appropriate objects at appropriate positions of appropriate webpages of the website 6, when a visitor requests one or more webpages of the website 6. Furthermore, the CMS 5 may obtain information regarding rules to be applied when the CMS 5 dynamically generates webpages, in a manner which will be described below, from the remote server 4.

According to an embodiment of the invention, a visitor accesses the website 6, via the client browser 2, which resides on a client device 7. In FIG. 1 the client device 7 is illustrated as a personal computer (PC), but it should be noted that the client device 7 could alternatively be a cell phone, a tablet, a TV, or any other suitable kind of client device allowing the visitor to access the website content, via the client browser 2. Thus, the visitor requests one or more webpages of the website 6. Upon this request, the CMS 5 dynamically generates the webpage(s) requested by the visitor. The dynamic generation of the webpage(s) includes that the CMS 5 injects one or more objects into the webpage(s) in accordance with one or more predefined rules, and in accordance with the information regarding the objects, which is obtained from the remote server 4. Accordingly, the dynamically generated webpage(s) include relevant and appropriate objects at appropriate positions of the dynamically generated webpage(s).

It should be noted that the CMS 5 may contact the remote server 4 upon receipt of a request from a visitor, in order to obtain the required information regarding the objects. As an alternative, the communication between the CMS 5 and the remote server 4 may take place independently of the communication between the client browser 2 and the CMS server 3. In the latter case, information regarding the objects may be stored at the CMS server 3, and is thereby readily available to the CMS 5 when a visitor requests one or more webpages of the website 6. This reduces the delay introduced when the CMS 5 dynamically generates the requested webpage(s), i.e. the response time of the website 6 is minimised. The communication between the CMS 5 and the remote server 4 may take place at regular intervals, such as once every hour, once every day, once every month, etc., and/or the communication may be initiated in response to certain events, such as updates to the information becoming available at the remote server 4.

Next, the dynamically generated webpage(s) 8 is/are supplied to the client browser 2 residing on the client device 7, and is/are thereby made available to the visitor.

Upon receipt of the webpage(s) 8, the client browser 2 contacts a third party service 9, prompted by one or more objects which were injected into the webpage(s) 8 by the CMS 5. The third party service 9 may, e.g., be in the form of a third party website, a third party web service, a third party server, etc. The third party service 9 is operated by a third party, i.e. it is not operated by the owner of the website 6. However, the third party service 9 may very well operate on behalf of the owner of the website 6.

When the third party service 9 is contacted by the client browser 2, it performs functionality. This may, e.g., include monitoring the behaviour of the visitor during the visit to the website 6 and/or gathering information regarding the visitor in other manners, e.g. by recognising an IP address related to the client device 7 and/or an ID of the client browser 2. The obtained information regarding the visit and/or the visitor may subsequently form the basis of statistical analysis, which can be provided to the owner of the website 6.

As an alternative, the third party service 9 may apply specific content or functionality to the webpage(s) 8 which have been supplied to the client browser 2.

Even though FIG. 1 shows that the client browser 2 contacts one third party service 9, it should be noted that it is within the scope of the present invention that the client browser 2 contacts two or more individual third party services 9, sequentially or simultaneously, e.g. prompted by two or more different objects injected into the webpage(s) 8 supplied to the client browser 2.

The system 1 further comprises a user interface (UI) 10, which is arranged to allow a web manager to access the remote server 4 in order to define one or more rules and/or one or more objects to be applied when the CMS 5 dynamically generates webpage(s) 8 upon request from a visitor. The user interface 10 thereby allows the web manager to easily manage the rules to be applied, and thereby which objects are to be injected where, and under which conditions, without requiring programming skills of the web manager.

It should be noted, that the system 1 may further comprise user interfaces allowing a web manager to access the CMS server 3 and/or one or more third party services 9, in order to define rules and/or objects to be applied when the CMS 5 dynamically generates webpage(s) 8.

Alternatively or additionally, the system 1 may comprise a similar user interface allowing a web manager to gain access to the CMS server 3 in order to define such rules.

The system 1 may further comprise a communication channel (not shown) between the remote server 4 and the third party service 9. Such a communication channel allows the remote server 4 to obtain information regarding changes in the third party service 9, which affects the objects and/or the rules applied when the CMS 5 dynamically generates webpage(s) 8. Thereby the remote server 4 is capable of updating information regarding objects and/or rules to reflect such changes. This may even be done automatically.

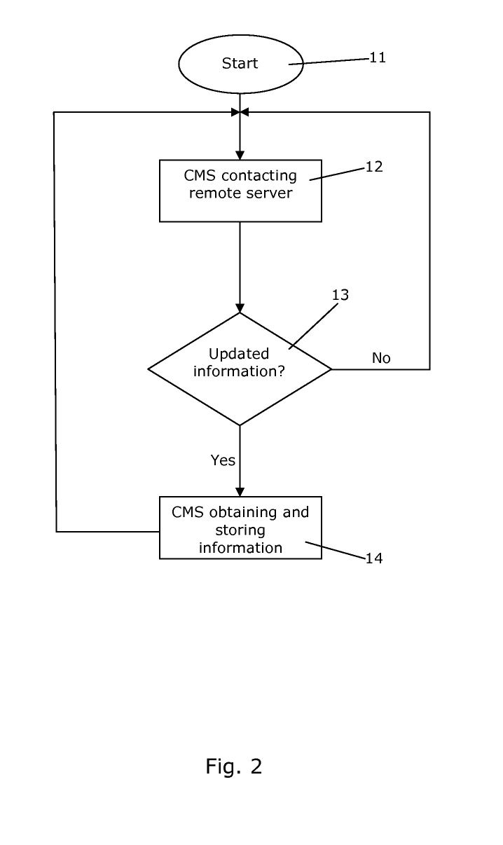

FIG. 2 is a flow diagram illustrating a method according to a first embodiment of the invention. The method may, e.g., be performed using the system illustrated in FIG. 1. The process is started at step 11. At step 12 a content management system (CMS) contacts a remote server in order to obtain information regarding objects which may be injected into webpages being dynamically generated by the CMS. Thus, at step 13 it is investigated whether or not updated information regarding one or more objects is available at the remote server. If this is the case, the CMS obtains and stores the updated information at the server where the CMS resides. Thereby the updated information is readily available to the CMS when a webpage is requested by a visitor. Subsequently, the process is returned to step 12, possibly after a suitable delay.

In the case that step 13 reveals that no updated information is available, the process is simply returned to step 12, possibly after a suitable delay.

The method illustrated in FIG. 2 may advantageously be performed at regular time intervals. In this case the CMS regularly checks whether or not updates to the information regarding objects and/or regarding rules to be applied are available at the remote server. When updates are available, the CMS obtains the updates at the CMS server, thereby ensuring that the most recent information is readily available to the CMS when a visitor requests a webpage. According to this embodiment, information is obtained by the CMS on the initiative of the CMS.

As an alternative to the method illustrated in FIG. 2, the remote server may contact the CMS when updated information becomes available at the remote server. According to this embodiment, the information is obtained by the CMS on the initiative of the remote server, and the step of CMS obtaining information may be regarded as initiated by a specific event, i.e. the updated information being available at the remote server.

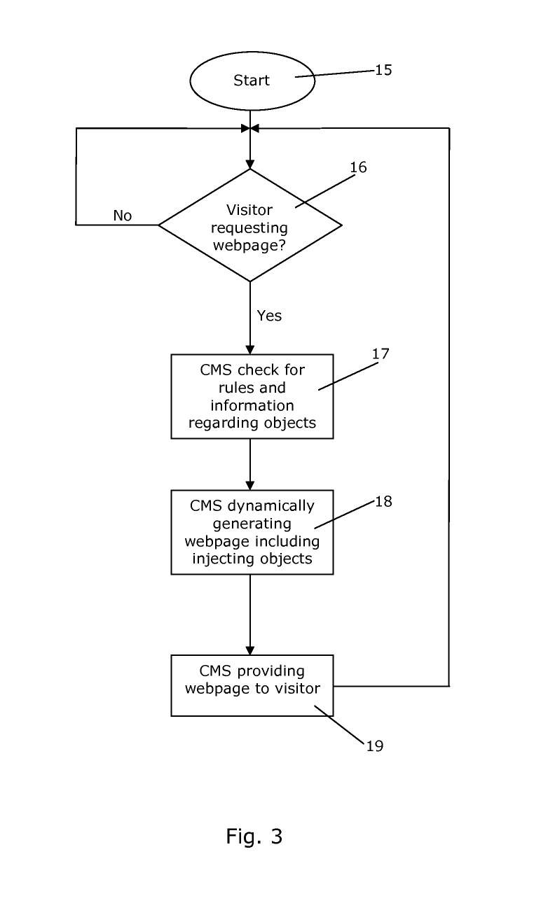

FIG. 3 is a flow diagram illustrating a method according to a second embodiment of the invention. The method may, e.g., be performed by means of the system illustrated in FIG. 1. The process is started at step 15. At step 16 it is investigated whether or not a visitor is requesting a webpage. If this is not the case, the process is returned to step 16 for continued monitoring regarding whether or not a visitor is requesting a webpage.

In the case that step 16 reveals that a visitor is requesting a webpage, a CMS checks for rules and information regarding objects. This may include the CMS contacting a remote server in order to obtain the required information. As an alternative, the CMS may have obtained the required information previously, and stored it at the server having the CMS residing thereon, e,g. in the manner described above with reference to FIG. 2. In this case the check for rules and information is performed ‘internally’ at the CMS server 5.

The objects are of a kind which comprises reference to one or more third party services. This has been explained in detail above. The rules define which objects should be injected into webpages to be generated by the CMS, where to inject the objects, and under which circumstances.

At step 18 the CMS dynamically generates a webpage. The webpage corresponds to the webpage requested by the visitor. The dynamic generation of the webpage includes injecting objects into the webpage, based on the information and the rules. Thus, the generated webpage includes relevant and appropriate objects at appropriate positions, in accordance with the rules and the obtained information regarding the objects.

At step 19 the CMS provides the dynamically generated webpage to the visitor, preferably via a client browser residing on a client device which the visitor uses for requesting the webpage. Accordingly, the webpage which is provided to the visitor includes the appropriate objects at the appropriate positions.

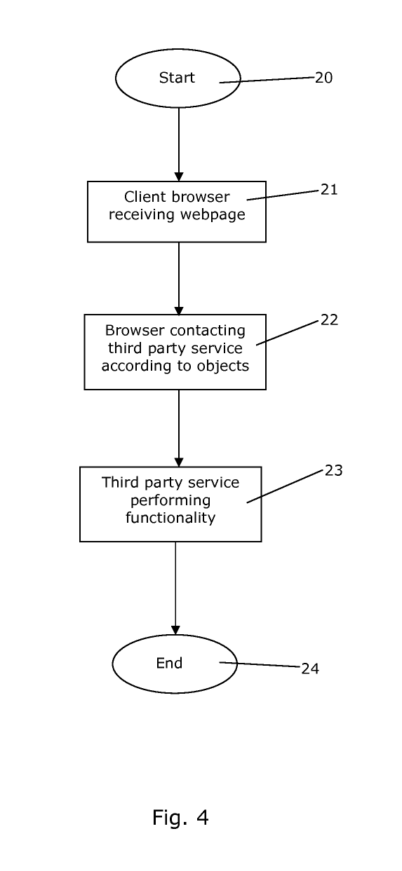

FIG. 4 is a flow diagram illustrating a method according to a third embodiment of the invention. The method may, e.g., be performed by means of the system illustrated in FIG. 1. The process is started at step 20. At step 21 a client browser receives a webpage. The webpage may advantageously be dynamically generated by a CMS, upon request from a visitor, e.g. in the manner described above with reference to FIG. 3. The webpage forms part of a website being visited by the visitor.

The received webpage includes one or more objects of the kind which comprises reference to one or more third party services, as described above. At least one of the objects provides instructions to the client browser to contact a third party service which is referenced by the object. Accordingly, at step 22 the client browser contacts the third party service.

In response to being contacted, the third party service performs functionality, at step 23. This may, e.g., include the third party service monitoring the behaviour of the visitor during the visit to the website and/or the third party service obtaining information regarding the visitor in other ways, as described above. The third party service may further perform analysis, e.g. statistical analysis, on the monitored behaviour and/or the obtained information regarding the visitor. The result of such an analysis may subsequently be delivered to the owner of the website being visited by the visitor.

Alternatively or additionally, the functionality performed by the third party service may include adjusting content presented to the visitor via the received webpage, and/or adding additional content to the webpage.

Finally, the process is ended at step 24.

The method illustrated in FIG. 4 may be repeated each time a visitor requests a webpage of the website.

1. A method for managing a website by means of a content management system (CMS), said website residing on a server, the method comprising the steps of:
the content management system obtaining, from a remote server, information regarding objects which may form part of webpages supplied to a visitor of the website, each of said objects comprising reference to one or more third party services,
a visitor requesting a webpage of the website,
the content management system dynamically generating a webpage matching the request of the visitor, including the content management system injecting one or more objects into the webpage in accordance with one or more predefined rules, and in accordance with the information obtained from the remote server, and
the content management system supplying the generated webpage to the visitor.

2. A method according to claim 1, further comprising the step of the content management system storing the information regarding the objects, obtained from the remote server, at the server, and wherein the step of the content management system dynamically generating a webpage is performed in accordance with the information obtained from the remote server and stored at the server.

3. A method according to claim 1, wherein at least one of the objects is a tag.

4. A method according to claim 1, wherein at least one of the objects contains instructions to a browser of the visitor to contact a third party website or web service.

5. A method according to claim 4, wherein the third party website or web service comprises functionality.

6. A method according to claim 4, wherein the third party website or web service is adapted to collect and analyse information about the visitor during a visit to the website.

7. A method according to claim 6, wherein the information collected and analysed includes behaviour of the visitor during a visit to the website.

8. A method according to claim 4, wherein at least one of the objects contains instructions to a browser of the visitor to contact a tag management service.

9. A method according to claim 1, wherein the step of the content management system obtaining information regarding objects is repeated in accordance with one or more predefined rules.

10. A method according to claim 1, wherein the remote server is or forms part of a cloud based service system.

11. A method according to claim 1, further comprising the steps of the content management system obtaining, from the remote server, information regarding the one or more predefined rules, and the content management system storing the information regarding the one or more predefined rules at the server.

12. A method according to claim 1, wherein the step of the content management system dynamically generating a web page comprises injecting one or more objects into the webpage in accordance with one or more predefined rules relating to a profile of the visitor, the dynamically generated webpage thereby being customized.

13. A method according to claim 12, further comprising the step of generating a profile for the visitor during the visit.

14. A method according to claim 1, wherein the step of the content management system dynamically generating a web page comprises injecting one or more objects into the webpage in accordance with one or more predefined rules relating to the web page being generated.

15. A method according to claim 1, further comprising the step of storing one or more objects at the server.

16. A method according to claim 1, further comprising the step of a web manager accessing the remote server via a user interface in order to define one or more rules to be applied during the step of dynamically generating a webpage.

17. A method according to claim 1, further comprising the step of a web manager accessing the content management system via a user interface in order to define one or more rules to be applied during the step of dynamically generating a webpage.

18. A method according to claim 1, further comprising the step of the remote server communicating with the third party service in order to provide information regarding one or more objects and/or regarding one or more predefined rules from the third party service to the remote server.

19. A system for managing a website arranged on a server, the system comprising:
a content management system (CMS) arranged on the server, the content management system allowing a visitor to request a web page of the website,
a remote server having information regarding objects residing thereon, each of said objects comprising reference to one or more third party services, and
a communication channel allowing the content management system to obtain information regarding objects from the remote server,
wherein the content management system is capable of dynamically generating a webpage matching a request from a visitor to the website, including the content management system injecting one or more objects into the webpage in accordance with one or more predefined rules, and in accordance with information obtained from the remote server.

20. A system according to claim 19, further comprising a storage device arranged on the server for storing information, obtained from the remote server, regarding objects.

21. A system according to claim 19, wherein the remote server comprises a user interface allowing a web manager to access the remote server in order to define one or more rules to be applied when dynamically generating a webpage.

22. A system according to claim 19, wherein the server comprises a user interface allowing a web manager to access the content management system in order to define one or more rules to be applied when dynamically generating a webpage.
